(19) United States
(12) Patent Application Publication
(10) Pub. No.: US 2009/0134102 A1
(43) Pub. Date: May 28, 2009

(54) SEPARATOR AND PROCESS FOR REMOVING SOLIDS FROM DRILLING LIQUIDS

(76) Inventors: Anthony Robert Cousins, Culcheth Cheshire (GB); Robert David Eden, Culcheth Cheshire (GB); Robert Nicholas Worrall, Basel (CH)

Correspondence Address: SHELL OIL COMPANY, P O BOX 2463, HOUSTON, TX, 772522463, US

(21) Appl. No.: 12/297,030

(22) PCT Filed: Apr. 11, 2007
(86) PCT No.: PCT/EP2007/053499

§ 371 Date: Oct. 13, 2008

(30) Foreign Application Priority Data
Apr. 13, 2006 (EP) 06112629.8

(51) Int. Cl. B01D 21/30; B01D 21/00

(52) U.S. Cl. 210/803; 210/170.04; 210/137; 210/800

(57) ABSTRACT

The invention provides a separator for the removal of solids from a drilling liquid, the separator comprising a tube settler (4) through which the drilling liquid can flow and beneath which a particle collection container is arranged for collecting solids separated from the liquid in the tube settler, wherein the solids collection container is a transportable container that is separate or separable from the tube settler. The invention further provides a process for the removal of solids from a drilling liquid using a separator, in which process a drilling liquid comprising solids is set to flow through a tube settler in order to allow the solids to settle out, thereby obtaining a solids depleted drilling liquid and an accumulation of solids. The invention also provides for the use of a separator comprising a tube settler to remove solids from a drilling liquid.

### FIELD OF THE INVENTION

The present invention relates to a separator for the removal of solids from a drilling liquid, a process for the removal of solids from a drilling liquid and the use of a separator comprising tube settler to remove solids from a drilling liquid.

### BACKGROUND OF THE INVENTION

When drilling a borehole into the earth, drilling liquids are used to transport solids particulates generated by drilling processes from a down-hole site of drilling to the surface. Typically drilling liquid is pumped down a hollow drill string to a drill bit. Solids particulates, such as drill cuttings, generated by the drill bit are suspended in the liquid and flow to the surface with the liquid through the annular space around the drill string. At the surface, either the liquid and the entrained particulates have to be dumped, or the particulates have to be separated from the liquid to enable recirculation of the liquid. In the latter case the separated particulates have to be dumped.

Dumping the liquid is often not an option, either for environmental reasons or economic reasons. Particularly in areas of human habitation, environmental damage from dumping large volumes of particle-laden liquid is unacceptable. In addition, particularly when using an expensive drilling liquid such as calcium formate solutions, the cost of the liquid itself makes dumping prohibitively expensive. A calcium formate solution is used when drilling through rocks of high specific gravity such as granite as granite particles are suspended more readily in a high specific gravity liquid such as a calcium formate solution.

Separation of particles from drilling liquids can be achieved using large settling tanks or lagoons, but these options cannot be used if space at the site of drilling is at a premium. Powered separation devices such as centrifugal separators can be used as they occupy relatively limited space but such devices are costly and wear out rapidly, particularly when handling abrasive particles, and therefore require intensive maintenance by skilled personnel.

There is a need to drill wells through rock of many different types in many different circumstances. The present invention is particularly applicable to circumstance in which drilling produces drilling liquid loaded with highly abrasive small particles and the local conditions constrain the available space and the level of acceptable environmental impact. Such circumstances can arise for example when drilling geothermal wells through igneous rock such as granite as granite produces small highly abrasive particles and geothermal wells are often wanted relatively near to human habitation.

Tube settlers are known and widely used in for example the water industry for clarifying relatively high volume flows of water. The term “tube settler” is used in this document to indicate a device comprising a bundle of tubes that are during normal operation inclined to the vertical and horizontal and through which a liquid to be clarified flows upwards such that each tube acts as a sedimentation vessel and settled solids flow down the tubes for collection in a basin beneath the tube bundle. Cleaning out sludge accumulated in the collection basin can be achieved by for example draining the basin and digging out the sludge. Generally collection basins are large permanent structures not suitable to applications where a site is only occupied temporarily and site space is at a premium.

It has been proposed in U.S. Pat. No. 6,171,483 to use a tube settler to remove particles from sea water in a subsea raw water injection system. Separated particles accumulate on the seabed but are dispersed by natural turbulence. Thus the problem of removing accumulated particles from beneath the tube settler does not arise.

### SUMMARY OF THE INVENTION

There is a need to provide a separator suitable for the removal of solids from a drilling liquid allowing for the efficient removal of solids and can be used near human habitation.

The present invention provides a separator for removal of solids from a drilling liquid, the separator comprising a tube settler through which the drilling liquid can flow and beneath which a particle collection container is arranged for collecting solids separated from the liquid in the tube settler, wherein the solids collection container is a transportable container that is separate or separable from the tube settler.

An advantage of the separator according to the invention that the solids collection container is separate or separable from the tube settler and transportable. Thus allowing easy off-site transport and storage of accumulated solids, avoiding the need for large on-site solids disposal facilities. In particular, standard industrial skips can be used as the transportable container.

The present invention further provides a process for the removal of solids from a drilling liquid using a separator, in which process a drilling liquid comprising solids is set to flow through a tube settler in order to allow the solids to settle out, thereby obtaining a solids depleted drilling liquid and an accumulation of solids.

The process allows for the effective and continuous onsite removal of solids from drilling liquids. After removal of the solids the drilling liquid may be recirculated to the drilling operation.

A further advantage of the invention is that the tube settler does not suffer from abrasive wear common to previously know processes using hydrocyclone units.

The present invention also relates to the use of a separator comprising a tube settler to remove solids from a drilling liquid.

Tube settlers are simple to operate and maintain, and can be compact when used in relatively low volume throughput application of removing solids from drilling liquids. The only moving components are simple pumps and valves, which are easy to install and maintain in remote areas. All components are relatively small and can be readily transported on conventional transport with conventional load handling equipment. All the equipment can be simply mounted on roadways or pavements, and expensive and disruptive site groundwork is not therefore required.

### BRIEF DESCRIPTION OF THE DRAWINGS

FIG. 1 is a schematic illustration of a separator including a tube settler arranged to deposit separated solids in a readily transportable skip;

FIG. 2 is a schematic illustration of the separation mechanism relied upon in the tube settler of FIG. 1;

FIG. 3 is a perspective view of a small section of the interior of the tube settler of FIG. 1 showing eight superimposed corrugated sheets, adjacent sheets being offset so that tubes are defined between each adjacent pair of sheets;

FIG. 4 is a cross-section through the sheets shown in FIG. 3;

FIG. 5 is a schematic perspective view of components making up the separator of FIG. 1 showing the components in the operative position with a lower section of the tube settler immersed in drilling liquid contained in the solid collection container;

FIG. 6 corresponds to the view of FIG. 5 but after the tube settler has been pivoted to a retracted position and excess drilling liquid has been pumped out of the solid collection container;

FIG. 7 schematically represents operational steps taken to switch the tube settler between adjacent solid collection containers; and

FIG. 8 is a schematic representation of the operational control of the separator of FIG. 1.

### DETAILED DESCRIPTION OF THE INVENTION

The separator according to the present invention is a separator that is suitable for removing solids from liquids and in particular removing solids from drilling liquid. The separator comprises a tube settler through which the drilling liquid can flow. The separator further comprises a transportable solids collection container. The tube settler and the solids collection container are separate or separable and arranged such that the solids collection container is located beneath the tube settler, so that it receives the solids separated by the tube settler.

The solids collection container may be a transported independently of the tube settler. Thus standard waste disposal skips can be used both as particle collection containers and particle transport containers in a highly efficient manner using standard vehicle-mounted skip handling equipment.

Preferably, the separator further comprises a knock-out tank. Reference herein to a knock-out tank is to a primary separation container for removing coarse solid particulates and reducing the solids loading of the liquid before it enters into the tube settler. A knock-out tank may be used to remove excess solids in order to reduce the accumulation of solids in the tube settler and reduce fouling in the tube settler. Furthermore, it may necessary to remove coarse solids particulates, which could block the tube settler.

Preferably, the solids collection container forms the knock-out tank. When the solids collection container forms the knock-out tank there is no need for an additional separate container to be added to the separator, reducing the footprint of the separator. Furthermore, all solids are collected in the same container.

Preferably, the tube settler is displaceable relative to the container between a position spaced from the solids collection container and an operative position in which a lower section of the tube settler is located within the solids collection container below a horizontal level to which the solids collection container may be filled with liquid. The tube settler may be pivotally supported so as to be pivotal between the operative position and a retracted position in which the lower section of the tube settler is located above an upper edge of the solids collection container to enable passage of the lower section over that edge of the solids collection container. The tube settler may be pivotally supported on a frame, which is displaceable relative to the solids collection container.

Preferably, the tube settler is comprised of a bundle of inclined tubes having an inlet for drilling liquid at their lower end, which, during normal operation, is immersed in drilling liquid, and having an outlet at their upper end that is connected to a liquid pump, the pump being operable to pump liquid up the tubes.

Reference herein to tubes is to elongated tubular passageways of any geometrical cross-sectional shape, such as but not limited to circular, squared and/or triangular shaped cross-sections. Preferably, the tube settler comprises an array of tubes defined by an assembly of superimposed corrugated sheets, adjacent sheets being offset so that tubes are defined between each adjacent pair of sheets. The cross-section and in particular the height of the tubes is chosen such that sufficient surface area is provided by the tube bundle for solids the settle out, but also such that the tubes are not blocked by solids during normal operation. Typical dimensions of the cross-section are such that that the cross-section encompasses a circle having a diameter in the range of from 0.01 to 0.10 meters, preferably of from 0.02 to 0.06 meters, in particular 0.04 meters.

The bundle of tubes may housed within a casing or any other suitable embodiment. Such an embodiment may improve handling of the tube bundle and increases the robustness of the tube settler.

The tubes in the tube bundle are in an inclined position with respect to the horizontal axis. Reference herein to inclined position is to the angle between the horizontal axis and the longitudinal axis of the tubes Preferably tube inclination, is between 30 and 60°, such as 45°. The inclined position of the tubes may promote the self-cleaning properties of the tube settler.

Preferably, a priming pump is provided to evacuate the upper end of the tube bundle. A suction break valve may be provided which if actuated opens the upper section of the casing to atmosphere. A sensor may monitor the particle content of liquid in the upper section of the casing to enable a control unit responsive to an output of the sensor to reduce the rate of flow of liquid through the tube settler if the sensed content exceeds a predetermined level.

Separators comprising a tube settler are particularly suitable for removing solids from drilling liquids, such as drilling liquids used for drilling geothermal wells. As mentioned hereinabove, tube settles are robust, do not required enhanced operating skills and are easy to assemble. Furthermore, such separators do not suffer from abrasive wear common to previously know processes using hydrocyclone units.

Therefore, the present invention also pertains to the use of separators comprising a tube settler to remove solids from a drilling liquid.

The invention further provides a process for the removal of solids from a drilling liquid, in particular to a process using the separator according to the invention. In this process a drilling liquid comprising solids is set to flow through the tube settler. Inside the tubes of the tube settler the solids are allowed to settle out under gravity and are deposited on the bottom side to the tubes. Thus are obtained a solids depleted drilling liquid and an accumulation of solids. Due to the inclined position of the tubes in the tube bundle, the accumulation of solids on the bottom side of the tube slides toward the lower end of the tube bundle.

Reference to drilling liquids herein is to liquids used to remove both heat and cuttings from the head of a drill when drilling wells. An example of a suitable drilling liquid is an aqueous brine solution. The brine solution may be any aqueous saline solution, such as for example seawater or calcium formate solution.

Reference herein to solids is to any solid material, typically solid particulate material, in particularly drilling cuttings, such as for example sand, minerals, granite. Typically, the solids can have a particle diameter in the range of from 1×10⁻⁷ to 1×10⁻² m, in particular of from 1×10⁻⁶ to 5×10⁻³ m, more in particular of from 5×10⁻⁶ to 75×10⁻⁶ m, wherein the latter range is a range that can suitably be handled by a tube settler.

Preferably, the drilling liquid passes through a knock-out tank prior to flowing through the tube settler. In the knock-out tank excess solids are removed, in particular coarse solid particulates. It will be appreciated that the required knock-out is related to the specific embodiment of the separator. Typically, when using drilling liquids, solids with a particle diameter in excess of 75×10⁻⁶ m are removed in the knock-out tank.

Preferably, the accumulation of solids in collected in the solids collection container. By collecting the solids in a solids collection container the solids can be removed from the process and transported off-site.

Preferably, a plurality of solids collection containers is provided and the tube settler is alternately applied to the solids collection containers. The solids collection containers may be for instance standard industrial skips. Such skips are cheap, readily available and allow for an easy and cheap transport of the solids off-site.

In the process according to the invention, a drilling liquid is set to flow through the tube settler. The drilling liquid may flow upwards or downwards through the tube settler. Preferably, the drilling liquid flows upwards. Typically, the lower end of the tube bundle is immersed in the drilling liquid comprising solids and the upper end of the tube bundle communicates drilling liquid pump, the pump being operable to pump liquid out of the upper end of the tube bundle such that liquid is caused to flow up the tubes. The solids settle out onto the bottom side of the tubes in the tube bundle. Reference herein to settling out is to the vertical displacement of the solids in the drilling liquid towards the bottom side of the tube. The velocity at which the solids settle out is among others influenced by the temperature of the drilling liquid. The temperature influences the viscosity of the drilling liquid. Preferably, the drilling liquid has a temperature in the range of from 20 and 90° C. As a high temperature has a positive effect on the viscosity it will be appreciated that any desired cooling of the drilling liquid is to take place downstream of the separator.

It will be appreciated that the maximum allowable flow velocity of the drilling liquid inside the tubes is related to the settle out speed of the solids particles and the length of the tubes. Furthermore, it is preferred that the flow condition of the drilling liquid inside the tubes is approximately laminar. Preferably, the flow velocity of the drilling liquid in the tube settler is chosen such that Reynolds number of the drilling liquid is 2000 or lower, preferable 400 or lower. Preferably, the flow velocity of the drilling liquid in the tube settler is chosen such that the Froude number drilling liquid is 10⁻⁵ or higher.

Typically, the drilling liquid comprises solids in the range of from 0.1 to 5 vol %, based on the drilling liquid, in particular of from 0.2 to 1.5 vol %, more in particular of from 0.5 to 1 vol %.

The separator and processes according to the invention described above have many commercially attractive features, particularly in applications where it is necessary to handle highly abrasive small solids particulates as for example are generated when drilling granite.

The separator according to the invention as described relies upon a floor-standing frame to support the tube settler in its operational position over a solids collection container, e.g. a skip. Alternative configurations are possible. For example, the tube settler could be supported on a frame that may be stored on the ground but is lifted by a forklift truck to rest on the edges of a skip when in the operational position. Assuming use of skips of standard size and configuration such an approach would ensure a predictable depth of penetration of the tube settler into the skip.

The separator according to the invention as described relies upon suction to draw drilling liquid up into the tube settler. As an alternative, it would be possible to apply pressure to the drilling liquid in the solids collection container to force drilling liquid up into the tube settler. For example, a flexible inflatable skirt could be provided around the tube settler which could be used to form a sealed enclosure between the tube settler and the solids collection container and that enclosure could then be pressurised to fill the tube settler.

The separator and process according to the invention as described require displacement of the tube settler into a solids collection container to achieve immersion of the bottom end to the tube bundle in liquid contained in the skip. It will be appreciated that in an alternative arrangement the tube settler could be fixed in position and a solids collection container lifted up from beneath the tube settler to achieve the necessary immersion. It is preferred however to make the tube settler displaceable as the tube settler is far less heavy than a solids collection container filled with solids.

It is possible to incorporate in the upper end of the tube bundle of the tube settler an oil removal system to reduce the risk of oil contamination. For example an oil skimmer can be incorporated in the separator according to the invention

The throughput capacity of the tube settler is a function of the cross-sectional area of the tube array. This is limited to the size of solids collection container into which the tube settler must fit. It will be appreciated however that two or more tube settlers operating in parallel in adjacent skips could be provide to meet relatively high throughput requirements.

Cleaning of the tube settler given its simple construction is not a problem, particularly as one tube settler unit could be taken out of commission temporarily for cleaning and simply replaced by another given the relative simplicity of the system.

### DETAILED DESCRIPTION OF THE FIGURES

An embodiment of the present invention will now be described, by way of example, with reference to the accompanying drawings, in which:

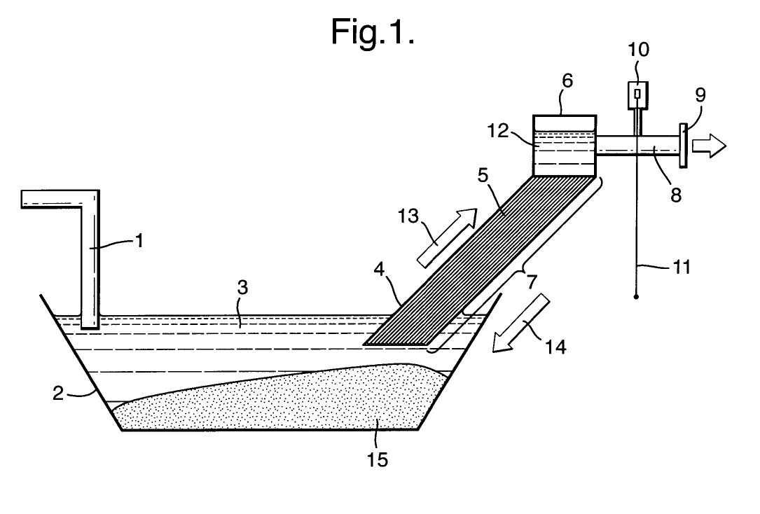

Referring to FIG. 1, drilling liquid comprising solids is delivered through an inlet 1 to a solids collection container 2, e.g. a skip. The skip is filled with drilling liquid to the level indicated by line 3.

A bottom section of a tube settler is immersed in the drilling liquid in the skip. The tube settler has an inclined main section 4 filled with a stack of corrugated sheets 5 and an upper header box section 6, the main and upper sections being enclosed in a common casing. A typical dimension of each sheet 5 in the direction indicated by line 7 can be 1.8 metres, but shorter or longer tubes can also be used, such as between 0.5 and 5 m. The sheets are offset so that open tubes are defined in spaces between adjacent sheets. The sheets may be inclined to the vertical by for example 45 degrees.

The upper section 6 defines an open space, which communicates with an outlet 8 and with the tubes defined between the corrugated sheets, and the main section 4 is open at the bottom so that drilling liquid can flow from the skip into the tubes defined between the corrugated sheets.

The outlet 8 extends to a coupling 9, which is connected by a flexible conduit (not shown) to a suction pump (not shown). A suction break valve 10 is connected to the outlet 7 and can be opened manually by pulling on chain 11 to open the outlet to atmosphere.

In operation, drilling liquid is received in the solids collection container (skip) 2 where a first settling of the coarse solids particulates can take place. The skip 2 therefore forms a knock-out tank. Drilling liquid containing the remaining fines solids is drawn by suction up the tubes defined between the corrugated sheets and into the upper section 6 to the level indicated by line 12. The flows through the inlet 1 and outlet 8 are substantially equalised so that levels within the system remain substantially as shown. Given appropriate control of the speed at which drilling liquid flows through the tubes of the tube settler solid particulates settle out onto the upper sides of the corrugated sheets. As a result, solids depleted drilling liquid is delivered to the upper section of the tube settler as indicated by arrow 13, and solids slip down the corrugated sheets to fall into the skip as indicated by arrow 14. A body 15 of settled solids thus accumulates in the skip 2.

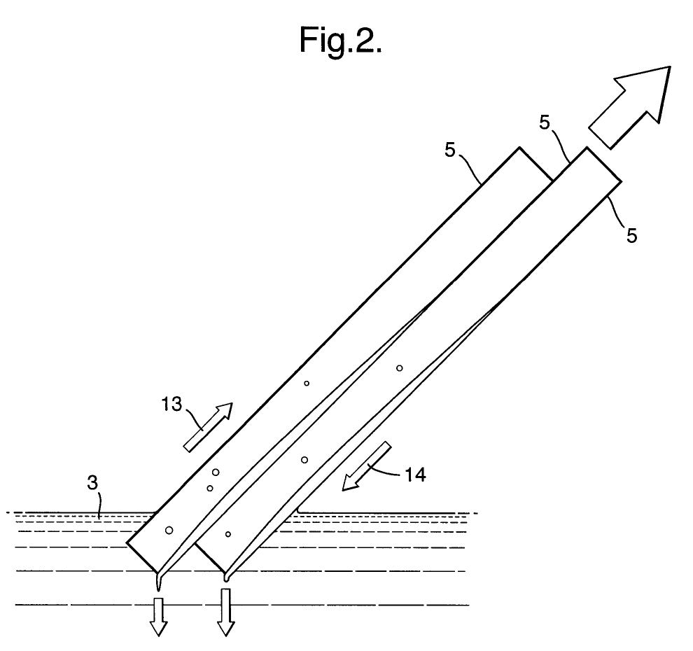

FIG. 2 illustrates the accumulation and downwards flow of accumulated solids in two adjacent tubes defined between the corrugated sheets. The bottom ends of the tubes are filled with drilling liquid comprising solids and the upper ends are filled with solids depleted drilling liquid from which most of the solid particulates have been removed. The solids content of the drilling liquid flowing out of the tubes is a function of the rate of flow through the tubes.

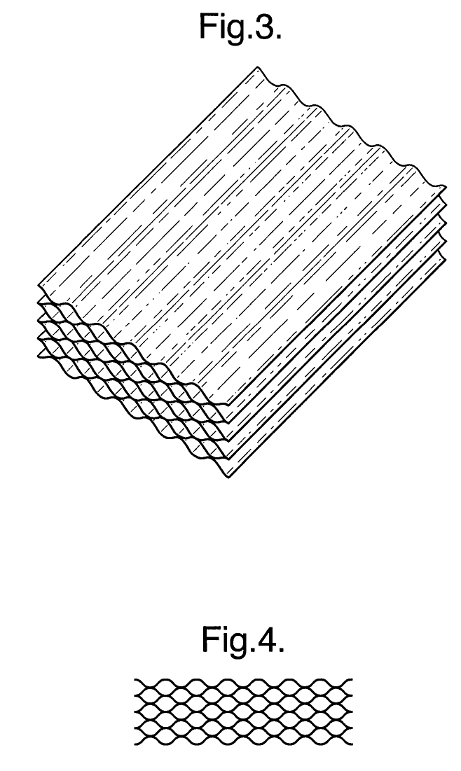

FIG. 3 illustrates the offset arrangement of the corrugated sheets giving rise to a highly compact array of parallel tubes also referred to as corrugated plate interceptor. FIG. 4 gives a cross-sectional view of the arrangement of corrugated sheets. Each of the tubes acts as an independent settling region. The corrugated sheets can be simply inserted into the casing defining the main section 4 of the tube settler. Readily available cheap plastics sheets can be used. Such sheets can be replaced or removed for cleaning by untrained staff and accordingly maintenance is not a problem.

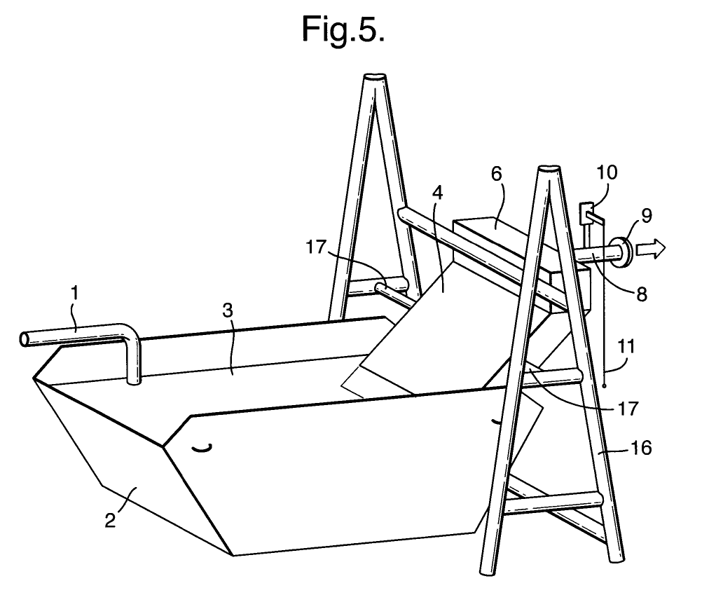

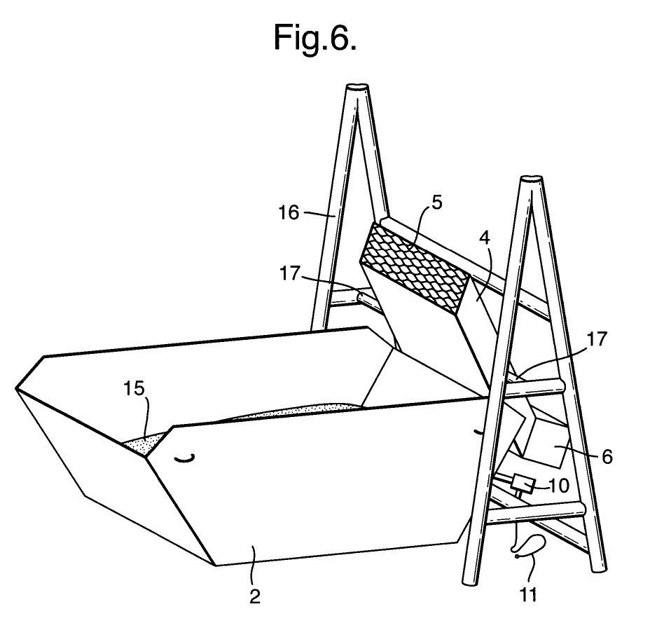

FIG. 5 shows how the tube settler may be supported on a simple scaffolding frame 16. As shown, the casing of the main section 4 of the tube settler supports axles 17 which are pivotally mounted on the scaffold 16. The axles 17 are positioned so that the assembly is substantially balanced and no great force is required to move the assembly on the axles. Assuming that the tube settler is initially filled with drilling liquid as shown in FIG. 1 and it is desired to lift the tube settler out of the drilling liquid in the skip 2, firstly the suction break valve 10 is opened so that all drilling liquid in the tube settler flows back into the skip 2. The tube settler can than be swung from the operational position shown in FIG. 5 to a retracted position as shown in FIG. 6. When positioned as shown in FIG. 6, either the skip 2 can be pulled clear of the tube settler, or the tube settler can be pulled back from the skip. In both cases, this makes it possible to lift the skip onto a vehicle for transport of the skip to a particle disposal site. No direct mechanical or manual handling of the solids is required.

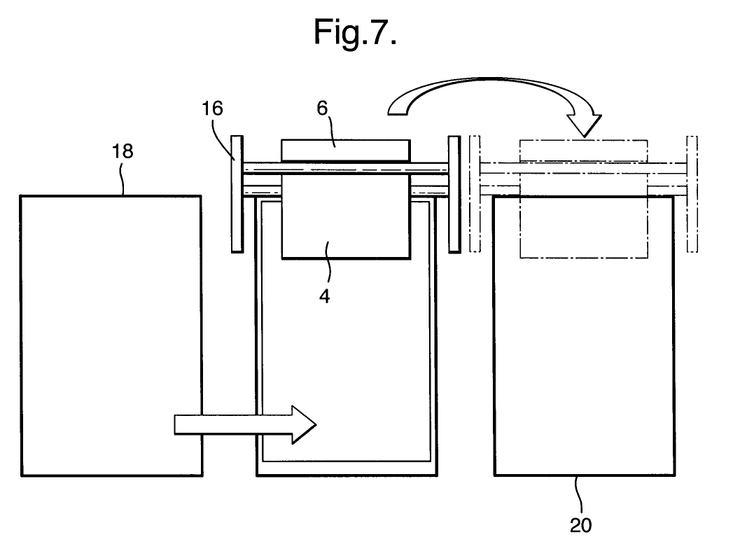

FIG. 7 illustrates a process, which minimises downtime and maximises utilisation of vehicle movements. This method requires the movement of the tube settler between adjacent skips. Movement of the tube settler can be readily achieved, for example by using a fork lift truck to lift and transport the assembly of the tube settler and the scaffold 16, or by mounting the scaffold frame 16 on lockable wheels (not shown) which can be unlocked to make it possible to wheel the assembly to where it is required.

As shown in FIG. 7, a first skip 18 has been previously filled with solids using the tube settler 4,6 carried on frame 16. The tube settler 4,6 has then been moved over a second skip 19 and solids separation continues, with solids accumulating in skip 19. A vehicle is then called with a further empty skip 20, which is placed as shown on the opposite side of skip 19 to skip 18. The same vehicle can then remove skip 18, taking the skip to an appropriate solids disposal site. When the skip 19 is full, the tube settler 4,6 can be moved over skip 20, and a further vehicle can be called to replace skip 18 and remove skip 19. The process can thus proceed with only short breaks in the settling process.

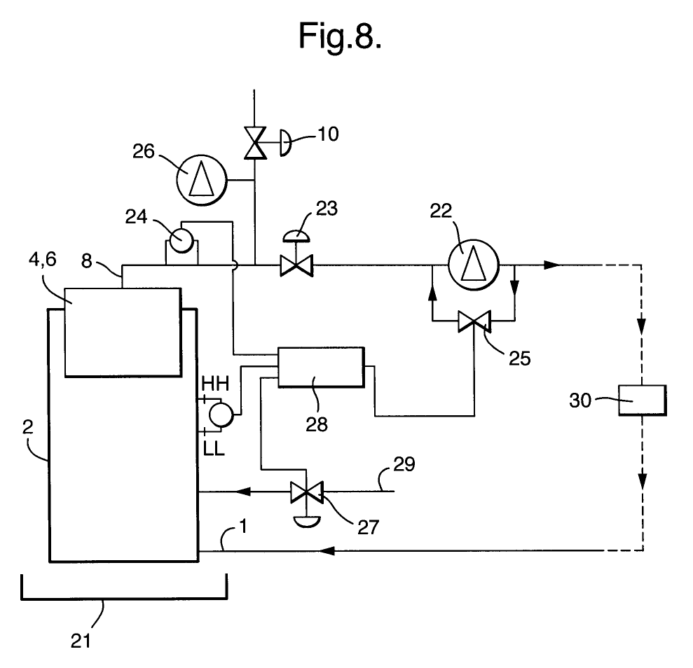

FIG. 8 illustrates a control system for controlling the operation of the tube settler shown in FIGS. 1 to 6 operating as described with reference to FIG. 7. In FIG. 8, the main and upper sections of the tube settler are represented as a single box 4, 6. Sensors HH and LL monitor the level of drilling liquid within the skip between upper (do not exceed to avoid loss of drilling liquid from the skip) and lower (keep above to maintain immersion of the bottom end of the tube settler) levels. These sensors may be mounted on the tube settler itself to avoid reliance upon skip-mounted components. The skip 2 may be placed in a bund 21 designed to retain any inadvertent loss of drilling liquid. A pump 22 is connected in series with an isolation valve 23 between the outlet 8 and a drill rig (not shown) through which drilling liquid is pumped to carry particulates back to the surface. The returning solids-laden drilling liquid is delivered via inlet 1 to the skip 2.

A turbidity meter 24 monitors the solids content of drilling liquid flowing through the outlet 8. A pump diversion valve 25 provides a bypass around the pump 22. A priming pump 26 is connected to the outlet 8 to enable air to be efficiently pumped out of the tube settler. A valve 27 is connected between a source 29 of make-up drilling liquid and an auxiliary inlet to the skip. The level sensors HH and LL, and turbidity meter 24 provide inputs to a control unit 28. The control unit provides outputs to valves 25 and 27.

In the described system, the main pump 22 is supplemented by a priming pump 26. Depending on the nature of the pump 22 the pump 26 may not be required, but it is preferred to use a relatively low volumetric capacity relatively high vacuum capacity priming pump 26 to ensure that sufficient air is removed to enable the pump 22 to circulate drilling liquid through the tube settler. The drilling liquid level in the upper section 6 of the tube settler could be monitored to turn on the pump 26 if the amount of air in the tube settler exceeds a predetermined limit.

Assuming that the starting conditions are an empty skip 2, with the tube settler in its operational position (FIG. 5), valves 10, 23, 25 and 27 shut, and pumps 22 and 26 off, then the first requirement is to fill the skip until the bottom of the tube settler is immersed. This is achieved by the control unit 28 opening the valve 27 and delivering drilling liquid until the upper limit sensed by sensor HH is reached. The valve 27 is then shut, and pump 26 is energised to pump out air from the tube settler. This causes the drilling liquid level in the skip to fall, but the sensor LL causes the valve 27 to open as required to maintain the drilling liquid level in the skip high enough to keep the tube settler partially immersed in the skip. The pump 26 is turned off once drilling liquid reaches it, to indicate that the tube settler is full of drilling liquid.

Removal of solids from drilling liquid can then proceed. The valve 23 is opened and the pump 22 is energised, driving drilling liquid through the drill rig, the drill string, the well 30 and back to the skip. As drilling proceeds, more drilling liquid is required to maintain the required drilling liquid level in the skip. This is supplied via valve 27 in response to the output of sensor LL. The turbidity of the drilling liquid in tube settler output 8 as monitored by meter 24 enables the control unit 28 to adjust the valve 25 so that the flow rate through the tube settler is not so great as to wash substantial numbers of solids through the tube settler.

When the skip 2 is full to the extent that the bottom of the tube settler is becoming obstructed by accumulated solids, the pump 22 is stopped, and valve 23 is closed. A pump (not shown) is then dropped into the skip 2 and used to pump free drilling liquid into the next skip to be used. The suction break valve 10 is then opened, causing drilling liquid in the tube settler to wash back into the skip 2. This drilling liquid is also pumped out into the next skip, and the tube settler is then transferred to that next skip. The cycle is then repeated.

FIG. 8 refers to monitoring the turbidity of the outflow from the tube settler. It will be appreciated that, depending on the degree of control of the quality of that outflow, many other parameters could be monitored and used to control system conditions. For example, it would be possible to monitor particle count, particle size, flow velocity, temperature, or volumetric flow rate.

### Experimental

The invention is illustrated by the following data for a simulation experiment related to the design of a tube settler for drilling liquid comprising solids, which is able to handle 3000 liter/min, while removing at least 98% of solids with a diameter over 22 micron. The results are shown in table 1.

TABLE 1

Input parameters:
Drilling liquid:
Type: brine
Density brine: 1.08 kg/m³
Temperature brine: 80° C.
Density solids: 2.6 kg/m³
98% removal: 22 micron
Flow rate: 3000 liter/min
Tube settler:
Tube length: 1.8 m
Tube diameter: 0.04 m
Tube cross-section: circular
Tube angle θ: 45°
Deduced parameters:
Tube cross-sectional area: 1257 mm²
Settling velocity: 1.206 mm/s
Minimal residence time: 47 sec
Tube flow rate: 3.0 liter/min
Number of tubes: 1000
Axial flow velocity in tube: 40 mm/s

1. A separator for the removal of solids from a drilling liquid, the separator comprising: a tube settler through which the drilling liquid can flow; and beneath which a particle collection container is arranged for collecting solids separated from the liquid in the tube settler, wherein the solids collection container is a transportable container that is separate or separable from the tube settler.

2. A separator according to claim 1, wherein the separator further comprises a knock-out tank.

3. A separator according to claim 2, wherein the solids collection container forms the knock-out tank.

4. A separator according to claim 1, wherein the tube settler is displaceable relative to the container between a position spaced from the container and an operative position in which a lower section of the tube settler is located within the container below a horizontal level to which the container may be filled with liquid.

5. A separator according to claim 4, wherein the tube settler is pivotally supported so as to be pivotal between the operative position and a retracted position in which the lower section of the tube settler is located above an upper edge of the container to enable passage of the lower section over that edge of the container.

6. A separator according to claim 5, wherein the tube settler is pivotally supported on a frame, which is displaceable relative to the collection container.

7. A separator according to claim 1, wherein the tube settler comprises a bundle of inclined tubes having an inlet for drilling liquid at their lower end, which, during normal operation, is immersed in drilling liquid, and having an outlet at their upper end that is connected to a liquid pump, the pump being operable to pump liquid up the tubes.

8. A separator according to claim 7, comprising a priming pump to partially evacuate the upper end of the tube bundle.

9. A separator according to claim 7, comprising a suction break valve which if actuated opens the upper section of the casing to atmosphere.

10. A separator according to claim 7, comprising a sensor arranged to monitor the particulate content of liquid in the upper section of the casing, and a control unit responsive to an output of the sensor to reduce the rate of flow of liquid through the tube settler if the sensed content exceeds a predetermined level.

11. A separator according to claim 1, wherein the tube settler comprises an array of tubes formed by an assembly of superimposed corrugated sheets being offset so that tubes are defined between each adjacent pair of sheets.

12. A process for the removal of solids from a drilling liquid using a separator, in which process a drilling liquid comprising solids is set to flow through a tube settler in order to allow the solids to settle out, thereby obtaining a solids depleted drilling liquid and an accumulation of solids.

13. A process according to claim 12, wherein the accumulation of solids is collected in a solids collection container beneath the tube settler.

14. A process according to claim 13, wherein a plurality of solids collection containers is provided and the tube settler is alternately applied to the solids collection containers.

15. A process according to claim 12, wherein the drilling liquid is set to pass through a knock-out tank prior to flowing through the tube settler.

16. A process according to claim 12, wherein the drilling liquid comprises solids in the range of from 0.1 to 5 vol %, based on the drilling liquid.

17. A process according to claim 12, wherein the drilling liquid comprises solids having a particle diameter in the range of from 1×10⁻⁷ to 1×10⁻² m, in particular of from 1×10⁻⁶ to 5×10⁻³ m, more in particular of from 5×10⁻⁶ to 75×10⁻⁶ m.

18. A process according to claim 12, wherein the flow velocity of the drilling liquid in the tube settler is chosen such that Reynolds number of the drilling liquid is 2000 or lower.

19. A process according to claim 12, wherein the flow velocity of the drilling liquid in the tube settler is chosen such that the Froude number drilling liquid is 10⁻⁵ or higher.

20. A process according to claim 12, wherein the separator is the separator for the removal of solids from a drilling liquid the separator comprising: a tube settler through which the drilling liquid can flow; and beneath which a particle collection container is arranged for collecting solids separated from the liquid in the tube settler wherein the solids collection container is a transportable container that is separate or separable from the tube settler.

21. Use of a separator comprising a tube settler to remove solids from a drilling liquid.
